(19) United States
(12) Patent Application Publication
(10) Pub. No.: US 2005/0263308 A1
(43) Pub. Date: Dec. 1, 2005

(54) Damping structure for pneumatic tool

(75) Inventor: Ching-Shun Chang, Taichung (TW)

Correspondence Address: BACON & THOMAS, PLLC, 625 SLATERS LANE, FOURTH FLOOR, ALEXANDRIA, VA, 22314, US

(73) Assignee: Hsiu-Ju Chen, Taichung (TW)

(21) Appl. No.: 11/126,238

(22) Filed: May 11, 2005

(30) Foreign Application Priority Data
May 26, 2004 (TW) 93208282

(51) Int. Cl. B25D 9/00

(52) U.S. Cl. 173/210

(57) ABSTRACT

A damping structure used in a pneumatic tool and coupled to an impact unit for absorbing shocks from the impact unit is disclosed to include a housing, which has a mounting portion, a bearing hole and an accommodating chamber formed in the mounting portion, and locating device disposed at the bottom side of the bearing hole, a sliding barrel, which accommodates the impact unit and has a barrel body axially slidably mounted in the accommodating chamber in an airtight manner, and a damper, which is connected to one end of the sliding barrel to buffer movement of the sliding barrel relative to the housing and which has an axially compressible and stretchable body formed of a plurality of axially elastic deformation portions.

### BACKGROUND OF THE INVENTION

1. Field of the Invention

The present invention relates to a pneumatic tool and more particularly, to a damping structure for pneumatic tool.

2. Description of the Related Art

A regular pneumatic tool, more particularly, a reciprocating type pneumatic tool produces a heavy vibrating force during the action of the impact unit. This vibrating force may cause an injury to the user's hand if it is not well absorbed.

Various damping designs and products have been disclosed for use in a pneumatic tool to eliminate or lessen shock waves. Because these designs and products commonly use coiled springs to absorb shocks, it is difficult to control the coefficient of elasticity, and the shock absorbing effects of these designs and products are not satisfactory. Due to high frequency oscillation, the parts wear quickly with use.

### SUMMARY OF THE INVENTION

The present invention has been accomplished under the circumstances in view. It is the main object of the present invention to provide a damping structure for pneumatic tool, which uses axially deformable and stretchable dampers to provide a satisfactory damping effect. It is another object of the present invention to provide a damping structure for pneumatic tool, which is easy and inexpensive to manufacture and has a high toughness.

To achieve these and other objects of the present invention, the damping structure damping structure is used in a pneumatic tool and coupled to an impact unit for absorbing shocks from the impact unit, comprising: a housing, the housing having a mounting portion, a bearing hole and an accommodating chamber formed in the mounting portion, and locating means disposed at a bottom side of the bearing hole; a sliding barrel adapted to accommodate the impact unit of the pneumatic tool, the sliding barrel having a barrel body axially slidably mounted in the accommodating chamber in an airtight manner; and a first damper adapted to buffer movement of the sliding barrel relative to the housing, the first damper having an axially compressible and stretchable body, the axially compressible and stretchable body being a tubular member comprised of a plurality of axially elastic deformation portions.

### BRIEF DESCRIPTION OF THE DRAWINGS

FIG. 1 is a side sectional assembly view of a damping structure according to the present invention.

FIG. 2 is a side view in section of the damping structure according to the present invention, showing the first damper and the second damper connected to the two distal ends of the sliding barrel.

FIG. 3 corresponds to FIG. 2 but showing an alternate form of the deformable and stretchable slots of the second damper.

FIG. 4 corresponds to FIG. 2 but showing another alternate form of the deformable and stretchable slots of the second damper.

FIG. 5 corresponds to FIG. 2 but showing still another alternate form of the deformable and stretchable slots of the second damper.

FIG. 6 is similar to FIG. 2 but showing each deformable and stretchable slot of the second damper mounted with a buffer material.

FIG. 7 shows the axially compressible and stretchable body of the second damper directly made of a buffer material according to the present invention.

FIG. 8 shows a sloping design of the deformable and stretchable slots of the second damper according to the present invention.

FIG. 9 shows a spiral design of the deformable and stretchable slots of the second damper according to the present invention.

FIG. 10 shows the axially compressible and stretchable body of the first damper formed of a plurality of bellows elastic deformation portions according to the present invention.

FIG. 11 is a sectional view taken along line 11-11 of FIG. 10.

FIG. 12 shows the axially compressible and stretchable body of the second damper formed of multiple series of bellows elastic deformation portions according to the present invention.

FIG. 13 is a sectional view taken along line 13-13 of FIG. 12.

### DETAILED DESCRIPTION OF THE INVENTION

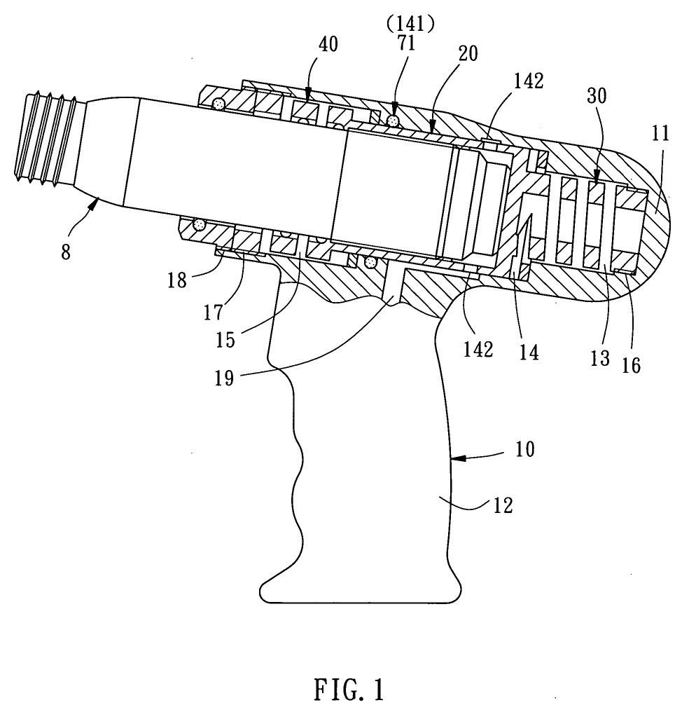

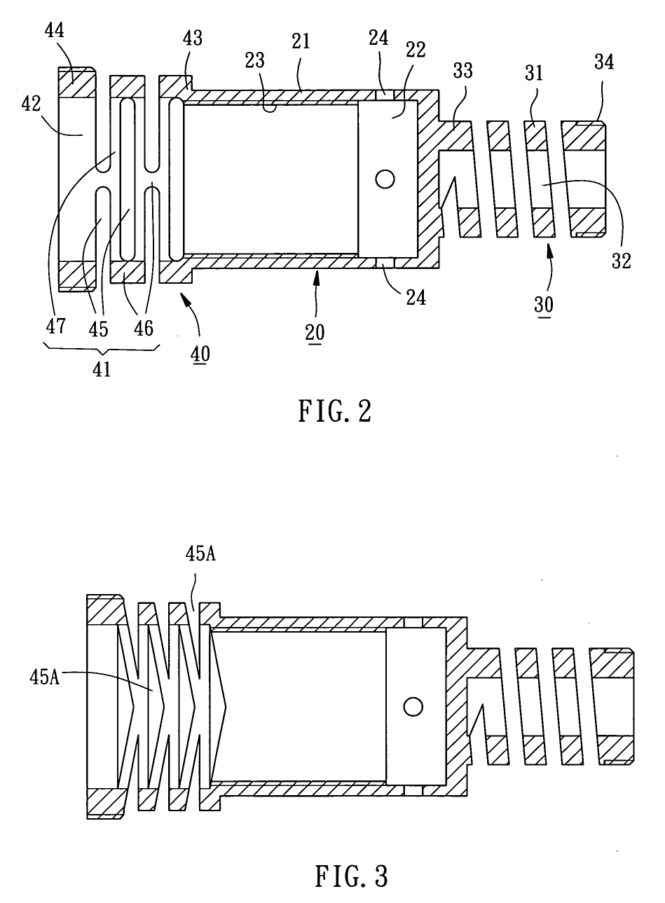

Referring to FIGS. 1 and 2, a damping structure is shown connected to an impact unit 8, comprising:

A housing 10 has a mounting portion 11, a handle 12 connected to the mounting portion 11, a first bearing hole 13 and an accommodating chamber 14 and a second bearing hole 15 formed in proper order in the mounting portion 11, a seal ring groove 141 and an air groove 142 respectively extending around the inside wall of the mounting portion 11 within the accommodating chamber 14, a first locating means (for example, a screw hole) 16 disposed at one end of the first bearing hole 13, a second locating means 17 and a positioning means 18 (both the second locating means 17 and the positioning means 18 form a screw hole) disposed near the orifice of the second bearing hole 15, and an air inlet 19 formed in the handle 12 and extending to the accommodating chamber 14. Further, a seal ring 71 is mounted in the seal ring groove 141 inside the housing 10.

A sliding barrel 20 has a barrel body 21 axially slidably inserted into the accommodating chamber 14 and peripherally surrounded by the seal ring 71 to prevent leakage of air, an air chamber 22 defined within the barrel body 21, an inner thread 23 formed in the air chamber 22 inside the barrel body 21 for receiving the impact unit 8, and a plurality of air holes 24 disposed in air communication between the air chamber 22 and the air groove 142 of the housing 10.

A first damper 30 has an axially compressible and stretchable body 31 shaped like a spirally extending coil, a center through hole 32 axially extending through two distal ends of the axially compressible and stretchable body 31, a first connecting portion 33 formed integral with and connected between one end of the axially compressible and stretchable body 31 and one end of the sliding barrel 20, and a second connecting portion 34 formed integral with the other end of the axially compressible and stretchable body 31 and fastened to the first locating means 16 of the housing 10.

A second damper 40 has an axially compressible and stretchable body 41, a center through hole 42 axially extending through two distal ends of the axially compressible and stretchable body 41, a first connecting portion 43 formed integral with and connected between one end of the axially compressible and stretchable body 41 and the other end of the sliding barrel 20 opposite to the first damper 30, and a second connecting portion 44 formed integral with the other end of the axially compressible and stretchable body 41 and fastened to the second locating means 17 of the housing 10. The axially compressible and stretchable body 41 of the second damper 40 is a tubular member having a plurality of axially elastic deformation portions 47 axially aligned in a line, a plurality of deformable and stretchable slots 45, and a plurality of connecting portions 46 respectively connected between each two adjacent axially elastic deformation portions 47 and respectively spaced between each two adjacent deformable and stretchable slots 45.

According to this embodiment, the sliding barrel 20, the first damper 30 and the second damper 40 are integrally injection-molded from plastics for the advantages of quick fabrication and low manufacturing cost. Preferably, MC nylon is used to make the sliding barrel 20, the first damper 30 and the second damper 40. Other elastic, oil-proof, and impact-resistant materials such as rubber, foamed materials, or urethane may be used. Alternatively, the sliding barrel 20, the first damper 30 and the second damper 40 can be separately made and then fastened together by welding or riveting, or through a screw joint.

The operation and action of the present invention are described hereinafter. As shown in FIG. 2, the axially compressible and stretchable body 31 of the first damper 30 and the axially compressible and stretchable body 41 of the second damper 40 are axially compressible and stretchable. More particularly, the adjacent axially elastic deformation portions 47 of the second damper 40 provide a relatively greater amount of deformation to absorb shocks effectively.

In the aforesaid embodiment, the first damper and the second damper can be made having the same structure, i.e., the first damper can be made having axially elastic deformation portions, deformable and stretchable slots, and connecting portions.

In addition to the aforesaid embodiment, the sliding barrel, the first damper and the second damper may be variously embodied.

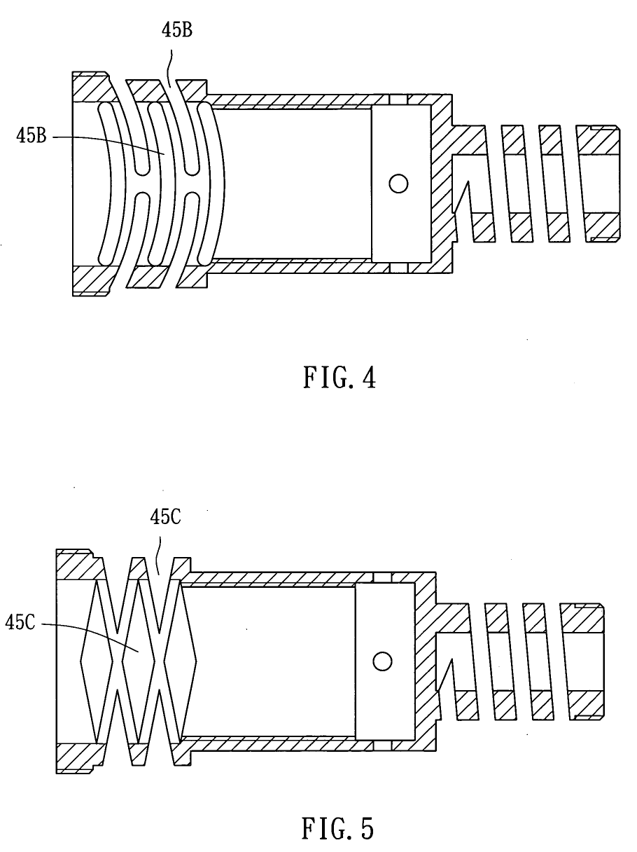

According to the embodiment shown in FIG. 3, the deformable and stretchable slots 45A are triangular slots alternatively arranged in reversed directions. According to the embodiment shown in FIG. 4, the deformable and stretchable slots 45B are smoothly arched. According to the embodiment shown in FIG. 5, the deformable and stretchable slots 45C are rhombic slots. Further, the deformable and stretchable slots of the second damper can be made having a circular, oval or trapezoidal shape, or a V-shaped or S-shaped profile.

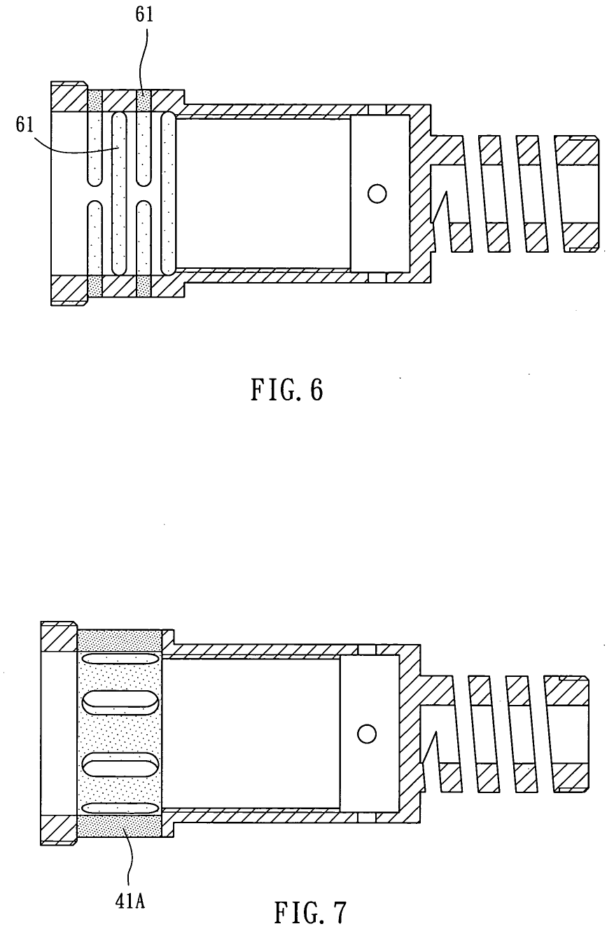

According to the embodiment shown in FIG. 6, each deformable and stretchable slot of the second damper is mounted with a buffer material 61. According to the embodiment shown in FIG. 7, the axially compressible and stretchable body 41A of the second damper is directly made of a buffer material having an axially extending center through hole.

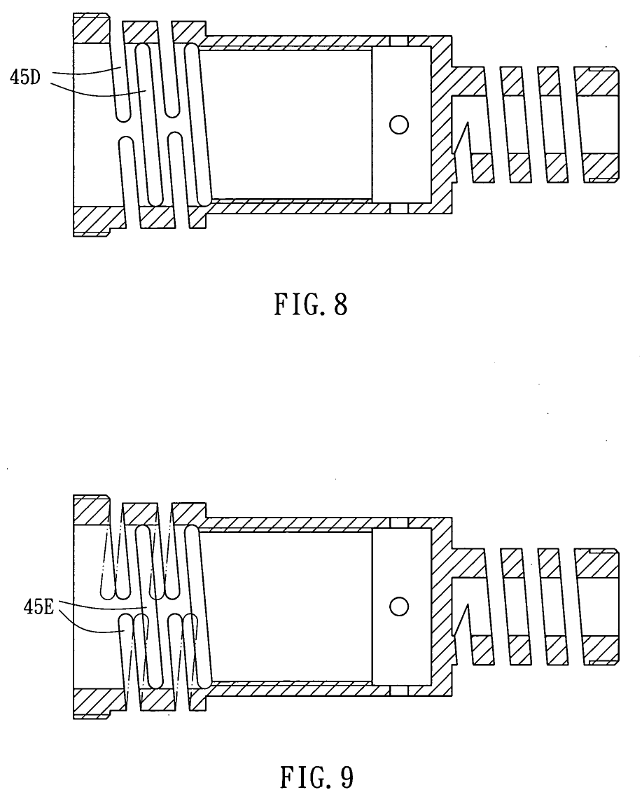

The deformable and stretchable slots of the second damper can be arranged in vertical as shown before, Alternatively, the deformable and stretchable slots of the second damper can be made in any of a variety of other arrangements. According to the embodiment shown in FIG. 8, the deformable and stretchable slots 45D of the second damper slope in one direction, defining a contained angle. According to the embodiment shown in FIG. 9, the deformable and stretchable slots 45E are arranged in a spiral manner.

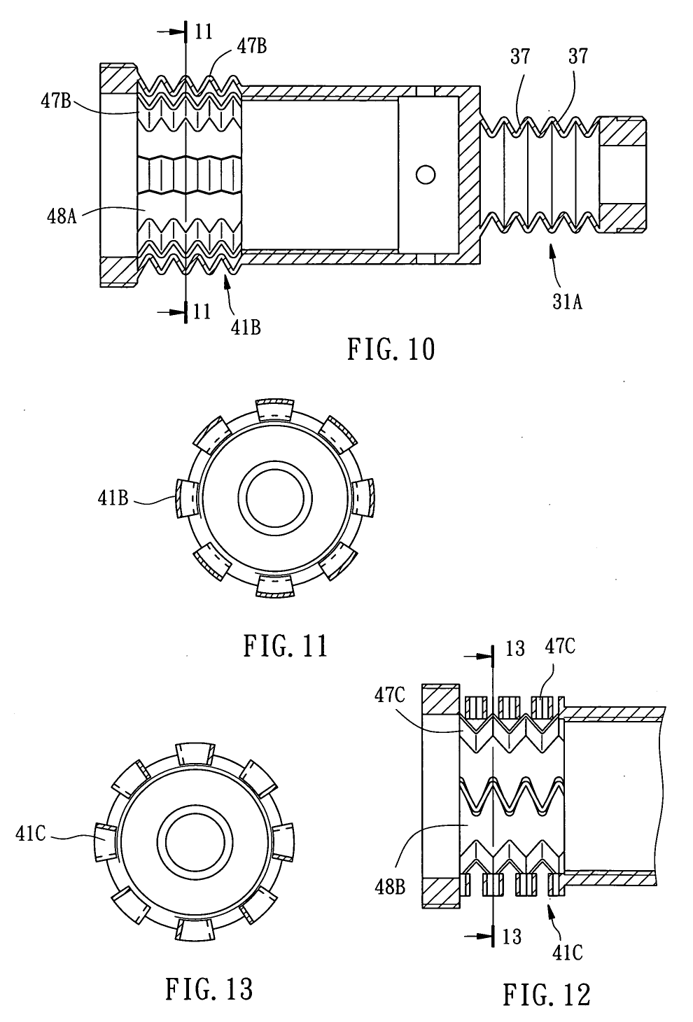

The first and second dampers can also be variously embodied. According to the embodiment shown in FIGS. 10 and 11, the axially compressible and stretchable body 31A of the first damper is comprised of a plurality of bellows elastic deformation portions 37 for compression and stretching in axial direction; the axially compressible and stretchable body 41Bb of the second damper is comprised of multiple series of elastic deformation portions 47B of bellows expansion structure and escape holes 48A.

According to the embodiment shown in FIGS. 12 and 13, the axially compressible and stretchable body 41C of the second damper is comprised of multiple series of elastic deformation portions 47C of bellows and escape holes 48B.

As indicated above, the damping structure for pneumatic tool as the following characteristics:

1. The dampers of the damping structure are axially deformable and stretchable to provide a satisfactory damping effect.

2. The dampers of the damping structure have a simple structure and high toughness, and are easy and inexpensive to manufacture.

1. A damping structure used in a pneumatic tool and coupled to an impact unit of said pneumatic tool for absorbing shocks from said impact unit, the damping structure comprising:
a housing, said housing having a mounting portion, a bearing hole and an accommodating chamber formed in said mounting portion, and locating means disposed at a bottom side of said bearing hole;
a sliding barrel adapted to accommodate said impact unit of said pneumatic tool, said sliding barrel having a barrel body axially slidably mounted in said accommodating chamber in an airtight manner; and
a first damper adapted to buffer movement of said sliding barrel relative to said housing, said first damper having an axially compressible and stretchable body, said axially compressible and stretchable body being a tubular member comprised of a plurality of axially elastic deformation portions.

2. The damping structure as claimed in claim 1, wherein said first damper is injection-molded from plastics.

3. The damping structure as claimed in claim 1, wherein said sliding barrel and said first damper are formed integral with each other.

4. The damping structure as claimed in claim 1, wherein said first damper is formed of a material selected from a group of materials including plastics, rubber, foamed materials and polyurethane.

5. The damping structure as claimed in claim 1, wherein said axially compressible and stretchable body of said first damper has a plurality of deformable and stretchable slots.

6. The damping structure as claimed in claim 5, wherein said deformable and stretchable slots are arranged in one of radially arranged type, obliquely arranged type, spirally arranged type and axially arranged type.

7. The damping structure as claimed in claim 5, wherein said deformable and stretchable slots comprise at least one type of elongated slots, triangular slots, trapezoidal slots, rhombic slots, circular slots, oval slots, S-shaped slots, arched slots.

8. The damping structure as claimed in claim 5, wherein said deformable and stretchable slots are respectively mounted with a buffer material.

9. The damping structure as claimed in claim 1, wherein said elastic deformation portions of said axially compressible and stretchable body is a bellows expansion structure.

10. The damping structure as claimed in claim 1, further comprising a second damper connected to one end of said sliding barrel opposite to said first damper.
